(19) United States
(12) Patent Application Publication
(10) Pub. No.: US 2013/0156068 A1
(43) Pub. Date: Jun. 20, 2013

(54) TEMPERATURE TEST SYSTEM

(71) Applicants: ZHI-YONG GAO, Wuhan City (CN); YU-LIN LIU, Wuhan City (CN); YUN-FEI ZHANG, Wuhan City (CN)

(72) Inventors: ZHI-YONG GAO, Wuhan City (CN); YU-LIN LIU, Wuhan City (CN); YUN-FEI ZHANG, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/569,265

(22) Filed: Aug. 8, 2012

(30) Foreign Application Priority Data
Dec. 20, 2011 (CN) 201110429325.8

(51) Int. Cl. G01K 7/00

(52) U.S. Cl. 374/170; 374/E07.001

(57) ABSTRACT

A temperature test system for detecting temperatures in a test chamber includes a switch module, a detecting module, a control module, a decoding module and a display module. The switch module inputs test instructions to select a test position in the test chamber. The detecting module detects a temperature signal of the test position according to the test instructions. The control module receives the temperature signal, and converts the temperature signal to a temperature value. The decoding module decodes the temperature value to digital signals. The display module receives the digital signals to display.

### BACKGROUND

1. Technical Field

The present disclosure relates to a temperature test system for testing reliability of an electronic device under different temperatures.

2. Description of Related Art

Temperature test is an important test for determining the reliability of an electronic device. The functions of the electronic device are tested under different temperatures, in a test chamber. However, a typical test chamber cannot detect temperatures of different positions in the test chamber, which may have an influence on precision of the test.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a temperature test system, which comprises a switch module, a control module, a detecting module, a decoding module and a display module.

FIG. 2 is a circuit diagram of the switch module, the control module and the detecting module of FIG. 1.

FIG. 3 is a circuit diagram of the decoding module and the display module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

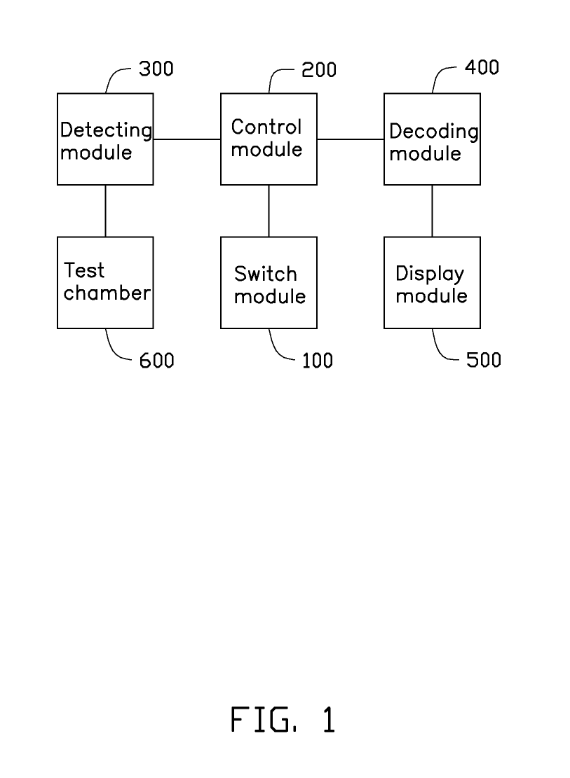

FIG. 1, illustrates a temperature test system in accordance with an embodiment. The temperature test system is adapted to detect temperatures of different test positions in a test chamber 600. The temperature test system includes a switch module 100, a control module 200, a detecting module 300, a decoding module 400 and a display module 500. The switch module 100 is adapted to input test instructions in the control module 200 to select a test position in the test chamber 600. The detecting module 300 is adapted to detect a temperature signal of the test position according to the test instructions, and transmit the temperature signal to the control module 200. The control module 200 is adapted to convert the temperature signal to a temperature value which is transmitted to the decoding module 400. The decoding module 400 is adapted to decode the temperature value to digital signals which are displayed on the display module 500.

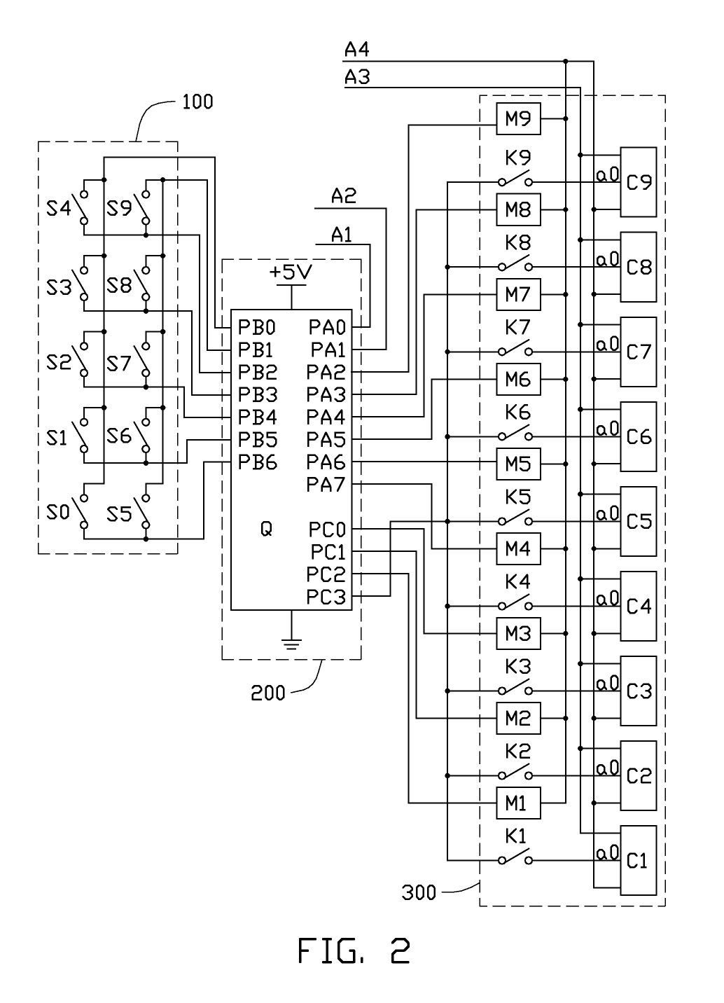

FIG. 2, illustrates the switch module 100, the control module 200 and the detecting module 300 in accordance with one embodiment. The switch module 100 includes a plurality of button switches S0-S9. The control module 200 includes a micro controller Q. The micro controller Q includes a serial data output terminal PA0, a clock signal output terminal PA1, a plurality of control signal output terminals PA2-PA7, PC0-PC2, a first digital signal input terminal PC3 and a plurality of control signal input terminals PB0-PB6. First terminals of the button switches S0-S4 are electrically connected to the control signal input terminal PB0. First terminals of the button switches S5-S9 are electrically connected to the control signal input terminal PB1. Second terminals of the button switches S0 and S5 are electrically connected to the control signal input terminal PB6. Second terminals of the button switches S1 and S6 are electrically connected to the control signal input terminal PB5. Second terminals of the button switches S2 and S7 are electrically connected to the control signal input terminal PB4. Second terminals of the button switches S3 and S8 are electrically connected to the control signal input terminal PB3. Second terminals of the button switches S4 and S9 are electrically connected to the control signal input terminal PB2.

The detecting module 300 includes a plurality of temperature sensors C1-C9, a plurality of winding units M1-M9 and a plurality of switch units K1-K9. Each of the plurality of temperature sensors C1-C9 includes a first digital signal output terminal a0. The plurality of control signal output terminals PA2-PA7, PC0-PC2 are grounded via the plurality of winding units M1-M9. The first digital signal input terminal PC3 is electrically connected to the first digital signal output terminals a0 of the plurality of temperature sensors C1-C9 via the plurality of switch units K1-K9. In one embodiment, the plurality of switch units K1-K9 are normally open switches.

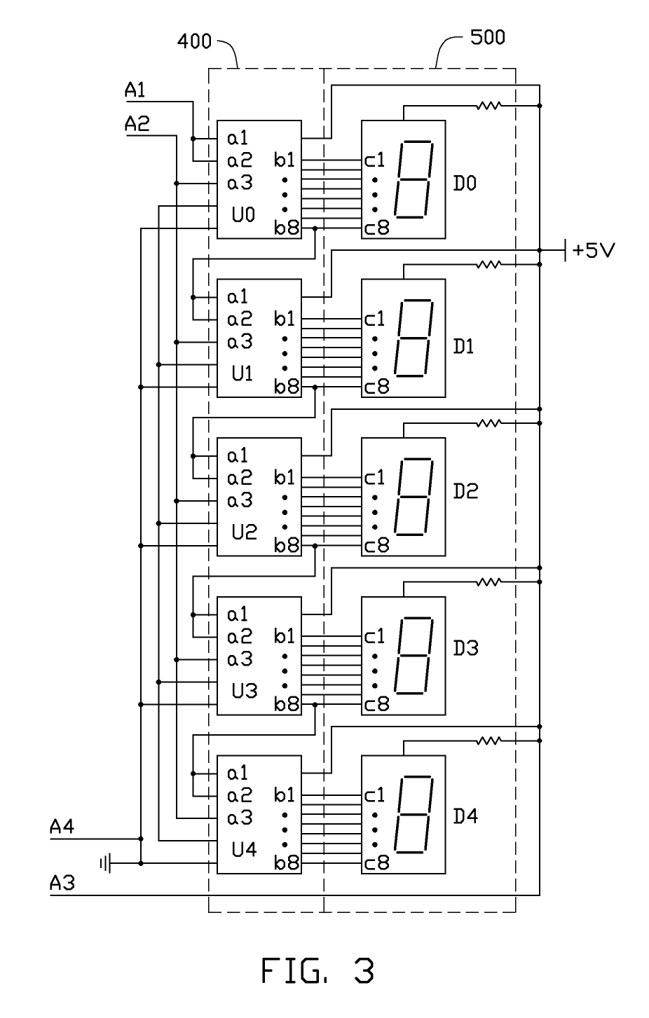

FIG. 3, illustrates the decoding module 400 and the display module 500 in accordance to one embodiment. The decoding module 400 includes a plurality of registers U0-U4. Each of the plurality of registers U0-U4 includes two serial data input terminals a1, a2, a clock signal input terminal a3 and a plurality of second digital signal output terminals b1-b8. The serial data input terminals a1, a2 of the register U0 are electrically connected to the serial data output terminal PA0 of the micro controller Q. The serial data input terminals a1, a2 of the register U1 are electrically connected to the second digital signal output terminal b8 of the register U0. The serial data input terminals a1, a2 of the register U2 are electrically connected to the second digital signal output terminal b8 of the register U1. The serial data input terminals a1, a2 of the register U3 are electrically connected to the second digital signal output terminal b8 of the register U2. The serial data input terminals a1, a2 of the register U4 are electrically connected to the second digital signal output terminal b8 of the register U3. The clock signal input terminals a3 of the plurality of registers U0-U4 are electrically connected to the clock signal output terminal PA1 of the micro controller Q.

The display module 500 includes a plurality of eight-segment numeral tubes D0-D4. Each of the plurality of eight-segment numeral tubes D0-D4 includes a plurality of second digital signal input terminals c1-c8. The plurality of second digital signal input terminals c1-c8 of the plurality of eight-segment numeral tubes D0-D4 are electrically connected to the plurality of second digital signal output terminals b1-b8 of the plurality of registers U0-U4.

In a working state, the plurality of temperature sensors C1-C9 are placed in different positions of the test chamber 600 to detect the temperature signals of these positions. The button switch S0 is pressed to start up the system. The plurality of button switches S1-S9 are corresponding to the plurality of temperature sensors C1-C9. One of the plurality of button switches S1-S9 is pressed to select one of the plurality of temperature sensors C1-C9 to receive the temperature signal. The micro controller Q outputs a high voltage level control signal at one of the plurality of control signal output terminals PA2-PA7, PC0-PC2. One of the plurality of winding units M1-M9 receives the high voltage level control signal and is powered on. One of the plurality of switch units K1-K9 is closed. The one of the plurality of temperature sensors C1-C9 selected by the one of the plurality of button switches S1-S9 transmits the temperature signal to the micro controller Q. The micro controller Q converts the temperature signal to a serial data which is transmitted to the decoding module 400. The decoding module 400 decodes the serial data to an eight-bit high voltage level and low voltage level signal which is transmitted to the plurality of eight-segment numeral tubes D0-D4. The plurality of eight-segment numeral tubes D0-D4 display the temperature value of the position corresponding to the one of the plurality of temperature sensors C1-C9 which is selected by the one of the plurality of button switches S1-S9.

In one embodiment, the eight-segment numeral tube D0 is used for indicating the temperature value of which one of the plurality of temperature sensors C1-C9 is displayed on the plurality of eight-segment numeral tubes D0-D4. The eight-segment numeral tube D3 includes a decimal point to precisely indicate the temperature value.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A temperature test system comprising:
a test chamber for accommodating an electronic device;
a switch module for inputting test instructions to select a test position in the test chamber;
a detecting module for detecting a temperature signal of the test position according to the test instructions;
a control module for receiving the temperature signal, and converting the temperature signal to a temperature value;
a decoding module for decoding the temperature value to digital signals; and
a display module for receiving the digital signals to display.

2. The temperature test system of claim 1, wherein the switch module comprises at least a first switch and a second switch; the control module comprises a first control signal input terminal, a second control signal input terminal and a third control signal input terminal; first terminals of the first switch and the second switch are electrically connected to the first control signal input terminal and the second control signal input terminal; and second terminals of the first switch and the second switch are electrically connected to the third control signal input terminal

3. The temperature test system of claim 2, wherein the control module further comprises at least a control signal output terminal and a first digital signal input terminal;
the detecting module comprises at least a temperature sensor, a winding unit and a switch unit; the temperature sensor comprises a first digital signal output terminal; the control signal output terminal is grounded via the winding unit; and the first digital signal input terminal is electrically connected to the first digital signal output terminal to receive the temperature signal.

4. The temperature test system of claim 3, wherein the switch unit is a normally open switch.

5. The temperature test system of claim 3, wherein the control module further comprises a serial data output terminal; the decoding module comprises at least a register; the register comprises two serial data input terminals; and the serial data output terminal is electrically connected to the two serial data input terminals to output the temperature value of the test position.

6. The temperature test system of claim 5, wherein the decoding module further comprises a plurality of second digital signal output terminals; the display module comprises at least an eight-segment numeral tube; the eight-segment numeral tube comprises a plurality of second digital signal input terminals; and the plurality of second digital signal output terminals are electrically connected to the plurality of second digital signal input terminals to output the digital signals of the temperature value.

7. The temperature test system of claim 6, wherein the first switch and the second switch are button switches.

8. A temperature test system for detecting temperatures in a test chamber, comprising:
a switch module for inputting test instructions to select a test position in the test chamber;
a detecting module for detecting a temperature signal of the test position according to the test instructions;
a control module for receiving the temperature signal, and converting the temperature signal to a temperature value;
a decoding module for decoding the temperature value to digital signals; and
a display module for receiving the digital signals to display.

9. The temperature test system of claim 8, wherein the switch module comprises at least a first switch and a second switch; the control module comprises a first control signal input terminal, a second control signal input terminal and a third control signal input terminal; first terminals of the first switch and the second switch are electrically connected to the first control signal input terminal and the second control signal input terminal; and second terminals of the first switch and the second switch are electrically connected to the third control signal input terminal

10. The temperature test system of claim 9, wherein the control module further comprises at least a control signal output terminal and a first digital signal input terminal; the detecting module comprises at least a temperature sensor, a winding unit and a switch unit; the temperature sensor comprises a first digital signal output terminal; the control signal output terminal is grounded via the winding unit; and the first digital signal input terminal is electrically connected to the first digital signal output terminal to receive the temperature signal.

11. The temperature test system of claim 10, wherein the switch unit is a normally open switch.

12. The temperature test system of claim 11, wherein the control module further comprises a serial data output terminal; the decoding module comprises at least a register; register comprises two serial data input terminals; and the serial data output terminal is electrically connected to the two serial data input terminals to output the temperature value of the test position.

13. The temperature test system of claim 12, wherein the decoding module further comprises a plurality of second digital signal output terminals; the display module comprises at least an eight-segment numeral tube; the eight-segment numeral tube comprises a plurality of second digital signal input terminals; and the plurality of second digital signal output terminals are electrically connected to the plurality of second digital signal input terminals to output the digital signals of the temperature value.

14. The temperature test system of claim 13, wherein the first switch and the second switch are button switches.
